(19) United States
(12) Patent Application Publication
(10) Pub. No.: US 2012/0294325 A1
(43) Pub. Date: Nov. 22, 2012

(54) LASER SYSTEM WITH SAFETY PROTECTION FUNCTION

(76) Inventor: Ching-Hou Kuo, Taichung City (TW)

(21) Appl. No.: 13/311,623

(22) Filed: Dec. 6, 2011

(30) Foreign Application Priority Data
May 19, 2011 (TW) 100117569

(51) Int. Cl. H01S 3/00

(52) U.S. Cl. 372/38.09

(57) ABSTRACT

A laser system with a safety protection function includes a main body and a detecting unit. The main body includes an object side portion corresponding in position to a target, and a laser-emitting module. The laser-emitting module is for providing a laser beam which is emitted at a position of the object side portion. The detecting unit is disposed at the main body, and includes a light-emitting element and a light-receiving element. The light-emitting element is for providing a light beam which is emitted at the position of the object side portion. The light-receiving element is for receiving the light beam which is reflected toward the object side portion. The laser-emitting module is prevented from emitting the laser beam when the light beam received by the light-receiving element reaches a predetermined luminous flux value.

### CROSS-REFERENCE TO RELATED APPLICATION

This application claims priority of Taiwanese Application No. 100117569, filed on May 19, 2011.

### BACKGROUND OF THE INVENTION

1. Field of the Invention

The present invention relates to a laser system capable of outputting a laser beam, more particularly to a laser system with a safety protection function.

2. Description of the Related Art

An optical axis adjusting structure for a range finder is disclosed in U.S. Pat. No. 6,344,894. A laser level with improved leveling adjustability is disclosed in U.S. Pat. No. 7,373,724. An optical sight with range finder is disclosed in U.S. Patent Application Publication No. 2006/0010762. All of the above-mentioned devices are commonly used laser devices. However, when users are operating such laser devices, they may turn laser beams toward themselves or others out of carelessness such that eyes may probably be injured.

### SUMMARY OF THE INVENTION

Therefore, an object of the present invention is to provide a laser device with a safety protection function which prevents eyes from being directly shot by laser beams.

Accordingly, the laser system of the present invention comprises a main body and a first detect unit.

The main body includes an object side portion corresponding in position to a target, and laser-emitting module. The laser emitting module is for providing a laser beam which is emitted at a position of the object side portion.

The first detecting unit is disposed at the main body. The first detecting unit includes a first light-emitting element and a first light-receiving element. The first light-emitting element is for providing a first light beam which is emitted at the position of the object side portion. The first light-receiving element is for receiving the first light beam which is reflected toward the object side portion. The laser-emitting module is prevented from emitting the laser beam when the first light beam received by the first light-receiving element reaches a first predetermined luminous flux value. The first light beam is non-visible light having a luminous intensity smaller than that of the laser beam.

This invention has the advantage that, after activating the laser-emitting module, the first detecting unit may perform detection. When the first light beam received by the first light-receiving element reaches the first predetermined luminous flux value, this means that there is an object located within certain range in front of the object side portion of the laser system. The object is probably the eye of the user or some other person, and the laser-emitting module is prevented from emitting the laser beam. In this way, an effect of safety protection function is achieved which prevents eyes from being directly shot by laser beams.

### BRIEF DESCRIPTION OF THE DRAWINGS

Other features and advantages of the present invention will become apparent in the following detailed description of the preferred embodiment with reference to the accompanying drawings, of which:

FIG. 1 is a sectional schematic view illustrating a preferred embodiment of a laser system with a safety protection function according to the present invention;

FIG. 2 is a block diagram of the preferred embodiment; and

FIG. 3 is a flow chart illustrating an operational flow of the preferred embodiment.

### DETAILED DESCRIPTION OF THE PREFERRED EMBODIMENT

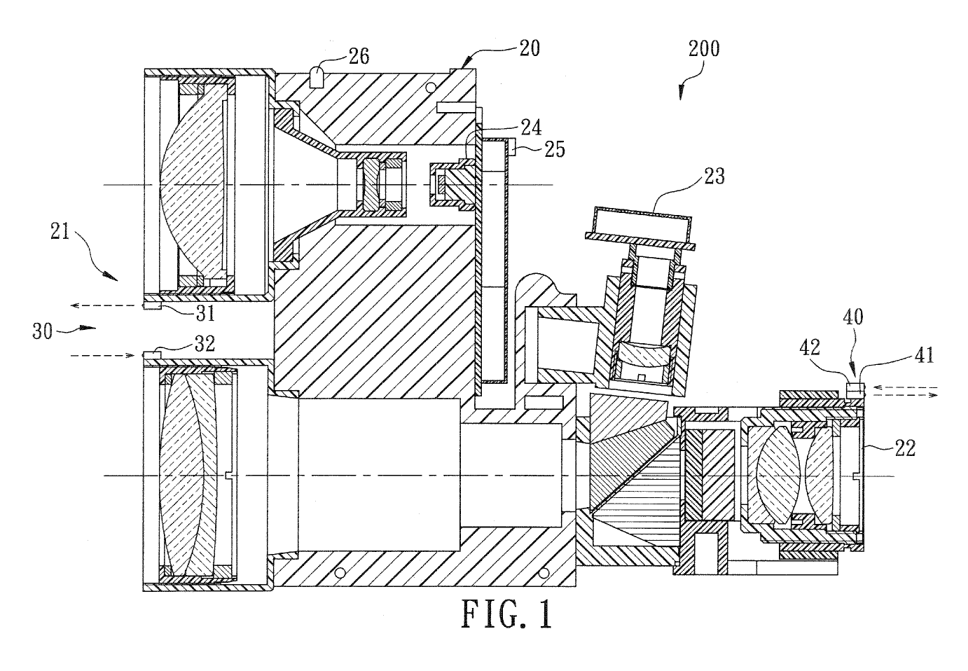

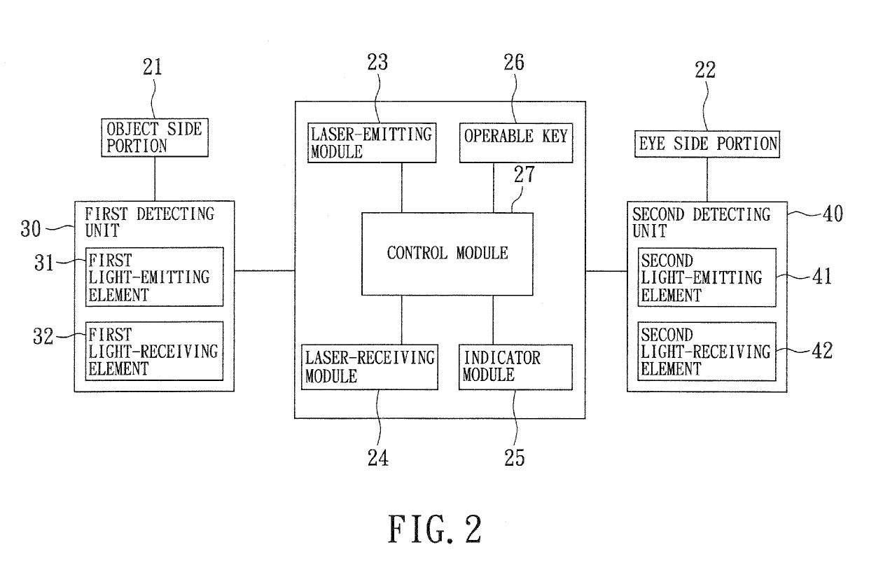

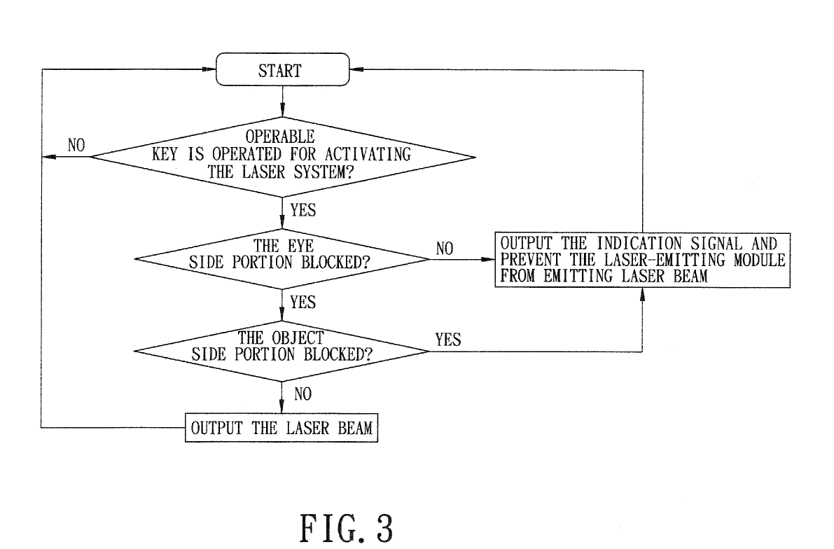

Referring to FIG. 1 to FIG. 3, a preferred embodiment of a laser system 200 with a safety protection function, according to the present invention, comprises a main body 20, a first detecting unit 30, and a second detecting unit 40.

The main body 20 includes an object side portion 21 corresponding in position to a target, an eye side portion 22 corresponding in position to a user's eye, a laser-emitting module 23, a laser-receiving module 24, an indicator module 25, a controller 26, and a control module 27 storing a first predetermined luminous flux value and a second predetermined luminous flux value. In this embodiment, the laser system 200 is realized as a telescope with a laser range finding function.

The laser-emitting module 23 is for providing a laser beam which is emitted at a position of the object side portion 21.

The laser-receiving module 24 is for receiving the laser beam which is reflected toward the object side portion 21, and the laser beam received by the laser-receiving module 24 is provided to the control module 27 for range finding calculation.

The indicator module 25 is for outputting an indication signal. In the preferred embodiment, flashing light is adopted as the indication signal. Moreover, in practice, the indication signal may be displayed on a display (not shown). Alternatively, a buzzer may be used as the indicator module 25, and the indication signal is an audible signal.

The controller 26 is for controlling enabled and disabled states of the laser-emitting module 23 by the user.

The first detecting unit 30 is disposed at the main body 20. The first detecting unit 30 includes a first light-emitting element 31 and a first light-receiving element 32.

The first light-emitting element 31 is for providing a first light beam which is emitted at the position of the object side portion 21. Preferably, the first light beam is non-visible light having a luminous intensity smaller than that of the laser beam.

The first light-receiving element 32 is for receiving the first light beam which is reflected toward the object side portion 21. The laser-emitting module 23 is prevented from emitting the laser beam when the first light beam received by the first light-receiving element 31 reaches a first predetermined luminous flux value. The indicator module 25 outputs the indication signal when the first light beam received by the first light-receiving element 32 reaches the first predetermined luminous flux value. In this embodiment, the first predetermined luminous flux value is determined according to a distance within a range of 200 cm in front of the object side portion 21.

The second detecting unit 40 is disposed at the main body 20. The second detecting unit 40 includes a second light-emitting element 41 and a second light-receiving element 42.

The second light-emitting element 41 is for providing a second light beam which is emitted at a position of the eye side portion 22. Preferably, the second light beam is non-visible light having a luminous intensity smaller than that of the laser beam.

The second light-receiving element 42 is for receiving the second light beam which is reflected toward the eye side portion 22. The laser-emitting module 23 is prevented from emitting the laser beam when the second light beam received by the second light-receiving element 42 does not reach a second predetermined luminous flux value. In this embodiment, the second predetermined luminous flux value is determined according to a distance within a range of 30 cm measured rearward from the eve side portion 22.

Furthermore, in this embodiment, the first light-emitting element 31 and the second light-emitting element 41 are both implemented using infrared diodes. The first light-receiving element 32 and the second light-receiving element 42 are both implemented using photo transistors. Luminous flux received by the first light-receiving element 32 and the second light-receiving element 42 are converted into electric signals that are inputted to the control module 27.

Operation of the laser system 200 is further illustrated hereinafter. When the control module 27 receives a trigger signal outputted from the controller 26, the second detecting unit 40 is configured to detect whether the second detecting unit 40 is blocked. When the second detecting unit 40 is not blocked, it is assumed that the controller 26 is not operated, and the trigger signal is probably generated as a result of short circuits or malfunction. Consequently, the control module 27 is configured to prevent the laser-emitting module 23 from emitting the laser beam, and the indicator module 25 is configured to output the indication signal. On the other hand, when the second detecting unit 40 is blocked, i.e., the user is properly facing the eye side portion 22 and operating the controller 26, the laser system 200 is properly operated. Subsequently, when it has been determined that the laser system 200 is properly operated, the first detecting unit 30 is configured to perform further detection. At this time, when the control module 27 determines that the first light beam received by the first light-receiving element 32 reaches the first predetermined luminous flux value, i.e., the object side portion 21 is blocked such as by the eye of the user or someone else, the control module 27 is configured to prevent the laser-emitting module 23 from emitting the laser beam, and the indicator module 25 is configured to output the indication signal. When it is determined that the object side portion 21 is not blocked, the control module 27 is configured to control the enabled state of the laser-emitting module 23. In this way, an effect of preventing eyes from being directly shot by laser beams may be achieved.

It is noted that in this embodiment, the telescope is given as an example for application of the laser system 200. In practice, the laser system 200 may be applied to an optical sight or a laser level. Since range finding is not required in the ordinary laser-level, structures of the eye side portion 22, the laser-receiving module 24, and the second detecting unit 40, as well as procedures for determining whether the eye side portion 22 is blocked may be omitted. Furthermore, the control module 27, which is for determining whether the first light beam received by the first light-receiving element 32 reaches the first predetermined luminous flux value, may be implemented using analog circuits or combinational logic circuits. In this way, microprocessors which store programs and data are not required in other embodiment of this invention for cost reduction.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A laser system with safety protection function, said laser system comprising:
a main body including
an object side portion corresponding in position to a target, and
a laser-emitting module for providing a laser beam which is emitted at a position of said object side portion; and
a first detecting unit disposed at said main body, said first detecting unit including
a first light-emitting element for providing a first light beam which is emitted at the position of said object side portion, and
a first light-receiving element for receiving the first light beam which is reflected toward said object side portion;
wherein said laser-emitting module is prevented from emitting the laser beam when the first light beam received by said first light-receiving element reaches a first predetermined luminous flux value; and
wherein the first light beam is non-visible light having a luminous intensity smaller than that of the laser beam.

2. The laser system as claimed in claim 1, wherein said main body further includes:
a laser-receiving module for receiving the laser beam which is reflected toward said object side portion; and
a controller for controlling enabled and disabled states of said laser-emitting module.

3. The laser system as claimed in claim 1, wherein said main body further includes an indicator module, said indicator module outputting an indication signal when the first light beam received by said first light-receiving element reaches the first predetermined luminous flux value.

4. The laser system as claimed in claim 1, wherein said main body further includes a control module storing the first predetermined luminous flux value, luminous flux received by said first light-receiving element being converted into an electric signal that is inputted to said control module, said control module preventing said laser-emitting module from emitting the laser beam when the first light beam received by said first light-receiving element reaches the first predetermined luminous flux value.

5. The laser system as claimed in claim 1, wherein said main body further includes an eye side portion corresponding in position to a user's eye, said laser system further comprising a second detecting unit disposed at said main body, said second detecting unit including:
a second light-emitting element for providing second light beam which is emitted at a position of said eye side portion, and
a second light-receiving element for receiving the second light beam which is reflected toward said eye side portion;
wherein said laser-emitting module is prevented from emitting the laser beam when the second light beam received by said second light-receiving element does not reach a second predetermined luminous flux value;
wherein the second light beam is non-visible light having a luminous intensity smaller than that of the laser beam.

6. The laser system as claimed in claim 5, wherein each of said first light-emitting element and said second light-emitting element includes an infrared light emitting diode, and each of said first light-receiving element and said second light-receiving element includes a phototransistor.
